(19) United States
(12) Patent Application Publication
(10) Pub. No.: US 2006/0080687 A1
(43) Pub. Date: Apr. 13, 2006

(54) Tray on which thin plate member can be mounted, and recording apparatus

(75) Inventor: Eiichi Miyashita, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/237,068

(22) Filed: Sep. 27, 2005

(30) Foreign Application Priority Data
Sep. 27, 2004 (JP) 2004-280715
Aug. 31, 2005 (JP) 2005-251382

(51) Int. Cl. G11B 17/04

(52) U.S. Cl. 720/603

(57) ABSTRACT

Holes are formed at positions corresponding to the edge position of a recording medium that is mounted on the mounting portion of a tray, so that light reflectivities from the holes relative to the recording medium differ. As for the main scanning direction, the holes are located at positions symmetrical to the centering position for the mounting portion in the main scanning direction, and as for the sub-scanning direction, located near the recording start position for the recording medium, relative to the contering position for the mounting portion in the sub-scanning direction. With this arrangement, after the holes have been detected and the centering position for the recording medium in the main scanning direction has been detected, the sub-feeding distance whereat the tray is to be moved to the search position can be shortened, and the shifting of the centering position for the recording medium due to the skewed feeding of the tray can be reduced or prevented.

### BACKGROUND OF THE INVENTION

The present invention relates to a tray on which a thin plate member, such as an optical disk, can be mounted. The present invention also relates to a recording apparatus.

Some types of ink jet printers, as example recording apparatuses or liquid ejection apparatuses, are designed so that they can perform recording by ejecting ink droplets directly onto the label faces of optical disks, thin plate members such as compact disks or DVDs (Digital Versatile Discs). When such an ink jet printer performs recording, generally, a thin plate member, such as an optical disk, is mounted on a plate shaped tray and is conveyed, together with the tray, along a conveying path within the ink jet printer (sub-scanning moving).

Various methods have been proposed for detecting the position for centering an optical disk to provide accurate printing of the label face (printing area) of the disk, without permitting a shift in the printing position. One of these methods is disclosed in patent document 1. According to this method, an identification mark is provided on a tray and an optical sensor is located at the bottom of a carriage that moves reciprocally in the main scanning direction, i.e., is positioned opposite the tray. The identification mark is read by the optical sensor to obtain data for the centering of an optical disk.

There is a further case wherein to center an optical disk that has been mounted on a tray, the disk is displaced slightly to adjust its position on the tray. Thus, in patent document 2 a method is disclosed whereby the edge of an optical disk is read by an optical sensor to obtain data for directly centering the optical disk.

Patent Document 1: JP-A-2002-127530

Patent Document 2: JP-A-2003-217259

After the position for centering the optical disk has been detected, the tray is moved to a printing start position search position) in order to initiate the printing of the optical disk. However, whichever of the above described detection methods is employed for centering, when a long sub-scanning distance is to be traveled by the tray, the actual position for centering the optical disk and the detected centering position may be shifted relative to each other as a result of tray skewing. In the above two patent documents, this problem is neither described, nor is there even a suggestion it may occur.

Therefore, while taking this situation into account, one objective of the present invention is to reduce, or prevent, the shifting of a contering position for an optical disk that occurs during a period extending from the detection of the centering position until the initiation of printing.

### SUMMARY OF THE INVENTION

In an embodiment according to a first aspect, a tray includes: a tray main body, having a plate shape, to be moved in a sub-scanning direction by a conveying roller, which conveys a recording medium to a location opposite a recording head that executes recording on the recording medium; and a mounting portion, which is formed in the tray main body and on which, as a recording medium, a thin plate member is to be mounted. At least two first marks, different in light reflectivity from the thin plate member, are provided at locations in the mounting portion that correspond to edge positions of the thin plate member that is mounted on the mounting portion. The first marks are symmetrically arranged to each other, in the main scanning direction, relative to the centering position of the mounting portion, and are arranged in a side of a recording start position for the thin plate member, in the sub-scanning direction, relative to the centering position of the mounting portion.

According to the first aspect, at least two first marks, different in light reflectivity from the thin plate member are arranged at locations symmetrical to each other relative to the centering position of the mounting portion in the main scanning direction. Thus, when the first marks are read by an optical sensor, a center position of the thin plate member in the main scanning direction can be obtained. Since in the sub-scanning direction these first marks are located in the side of the recording start position for the thin plate member, relative to the centering position of the mounting portion in the sub-scanning direction, and after the first marks have been read, the distance in the sub-scanning direction the tray is to be moved to the recording start position (the search position) can be shortened. Therefore, the shifting of the center position of the thin plate member due to the skewing of the tray can be reduced, or prevented.

In a second aspect, the first marks are formed as holes. According to this aspect, since holes are employed as the first marks, forming first marks different in light reflectivity from the thin plate member is easy.

In a third aspect, the tray of the first or the second aspect is featured in that the mounting portion can mount a plurality of types of thin plate members thereon. According to this aspect, recording can be performed on multiple types of thin plate members.

In a fourth aspect, the tray of the third aspect is featured in that the first marks are provided at positions corresponding to edge locations of the plurality of types of thin plate members.

According to this aspect, since the first marks are provided at positions corresponding to the edge locations of multiple types of thin plate members, the shifting of the centering positions of multiple types of thin plate members can be prevented.

In a fifth aspect, the tray of one of the first to the fourth aspects is featured in that at least two second marks different in light reflectivity from the tray main body are provided outside the mounting portion, and are positioned at locations symmetrical to each other, in the main scanning direction, relative to the centering position of the mounting portion.

According to the fifth aspect, since at least two second marks different in light reflectivity from the tray main body are provided outside the mounting portion, and are positioned at locations symmetrical to each other, in the main scanning direction, relative to the centering position of the mounting portion, the centering position of the mounting portion in the main scanning direction can be detected. Therefore, when the center position of the thin plate member in the main scanning direction can not be appropriately detected by using the first marks, e.g., when the edge of the thin plate member can not be detected, or when an aberrant detection result (an abnormal value) is obtained, the center position for use in the recording operation can be determined by using the second marks.

In a sixth aspect, the tray of the fifth aspect is featured in that the second marks are provided, in the side of the recording start position for the thin plate member, in the sub-scanning direction, relative to the centering position of the mounting portion.

According to the sixth aspect, since the second marks are provided, in the side of the recording start position for the thin plate member, in the sub-scanning direction, relative to the centering position of the mounting portion, even when the first marks are read and thereafter the second marks are read, the distance in the sub-scanning direction the tray is to be moved to the recording start position (the search position) can be shortened. Therefore, the shifting of the centering position of the mounting portion due to the skewing of the tray can be reduced, or prevented.

In a seventh aspect, a tray includes: a tray main body, having a plate shape, to be moved in a sub-scanning direction by a conveying roller, which conveys a recording medium to a location opposite a recording head that executes recording on the recording medium; and a mounting portion, which is formed in the tray main body and on which, as a recording medium, a thin plate member is to be mounted. At least two second marks different in light reflectivity from the tray main body are provided outside the mounting portion. The second marks are arranged symmetrical to each other, in a main scanning direction, relative to the centering position of the mounting portion in the main scanning direction, and are arranged in a side of a recording start position for the thin plate member, in the sub-scanning direction, relative to the centering position of the mounting portion.

According to the seventh aspect, the centering position of the mounting portion in the main scanning direction can be detected by using the second marks. Therefore, when the center position of the thin plate member in the main scanning direction can not be appropriately detected by using the first marks, e.g., when the edge of the thin plate member can not be detected, or when an aberrant detection result (an abnormal value) is obtained, the centering position for use in the recording operation can be determined by using the second marks. Furthermore, since in the sub-scanning direction the second marks are located in the side of the recording start position for the thin plate member relative to the centering position of the mounting portion in the sub-scanning direction; after the second marks have been read, the distance the tray is to be moved in the sub-scanning direction to the recording start position (the each position) can be shortened. Thus, the shifting of the centering position of the mounting portion due to the skewing of the tray can be reduced, or prevented.

In an embodiment according to an eighth aspect, a recording apparatus includes: a carriage that has a recording head for recording on a recording medium and that is driven to reciprocate in a main scanning direction; a conveying roller that is disposed in an upstream side relative to the recording head in a conveying path along which the recording medium is to be conveyed, and that conveys the recording medium to a region opposite the recording head; and an optical sensor, provided on the carriage at a location opposite the conveying path, for detecting reflective change in the conveying path. The recording apparatus further includes: a carriage position detecting means for detecting position of the carriage in the main scanning direction; a conveying amount detecting means for detecting conveying amount of the recording medium by the conveying roller; and a controller into which detection information of the optical sensor, the carriage position detecting means and the conveying amount detecting means arc respectively input, and that drives the carriage and the conveying roller in accordance with the input information. The recording apparatus is configured to be capable of conveying a tray including a plate-shaped tray main body capable of being conveyed by the conveying roller in the sub-scanning direction and a mounting portion which is formed in the tray main body and on which a thin plate member is mountable as a recording medium. To obtain the center position of the thin plate member in the main scanning direction, the controller detects two edge positions, which are located at positions symmetrical to each other in the main scanning direction relative to the center position of the thin plate member in the main scanning direction, by sensing an edge of the thin plate member in the main scanning direction with the optical sensor, which edge is located in a side of a recording start position in the sub-scanning direction relative to the center position of the thin plate member. Thereafter, the controller drives the conveying roller to position the recording head at the recording start position for the thin plate member.

According to this aspect, to obtain the center position of the thin plate member in the main scanning direction, the edge of the thin plate member, which is located in the side of the recording start position in the sub-scanning direction relative to the center position of the thin plate member, is sensed in the main scanning direction with the optical sensor, and thereafter the tray is fed to the recoding start position (the search position). Therefore, the distance the tray is to be fed to the start position after the sensing is executed to detect the main scanning direction center position of the thin plate member can be reduced. Consequently, the shifting of the center position of the thin plate member in the main scanning direction due to the skewing caused by feeding the tray in the sub-scanning direction can be reduced or prevented.

In a ninth aspect, the recording apparatus of the eighth aspect is featured in that before the controller executes the sensing in the main scanning direction with the optical sensor, to obtain the center position of the thin plate member in the sub-scanning direction, the controller senses an edge of the thin plate member in the sub-scanning direction to detect two edge positions that are located at positions symmetrical to each other, in the sub-scanning direction, relative to the center position of the thin plate member.

According to this aspect, by sensing the edge of the thin plate member in the sub-scanning direction, the center position of the thin plate member in the sub-scanning direction is directly obtained. Therefore, the sub scanning direction center position of the thin plate member can be obtained accurately.

In a tenth aspect, a recording apparatus includes: a carriage that has a recording head for recording on a recording medium and that is driven to reciprocate in a main scanning direction; a conveying roller that is disposed in an upstream side relative to the recording head in a conveying path along which the recording medium is to be conveyed, and that conveys the recording medium to a region opposite the recording head; and an optical sensor, provided on the carriage at a location opposite the conveying path, for detecting reflective change in the conveying path. The recording apparatus further includes: a carriage position detecting means for detecting position of the carriage in the main scanning direction; a conveying amount detecting means for detecting conveying amount of the recording medium by the conveying roller; and a controller into which detection information of the optical sensor, the carriage position detecting means and the conveying amount detecting means are respectively input, and that drives the carriage and the conveying roller in accordance with the input information. The recording apparatus is configured to be capable of conveying a tray including a plate-shaped tray main body capable of being conveyed by the conveying roller in the sub-scanning direction and a mounting portion which is formed in the tray main body and on which a thin plate member is mountable as a recording medium. The tray is configured according to any one of the first to seventh aspects. To obtain the center position of the thin plate member in the main scanning direction, the controller detects boundary positions between the first marks and the thin plate member by executing sensing in the main scanning direction with the optical sensor Thereafter, the controller drives the conveying roller to position the recording head at the recording start position for the thin plate member.

According to this aspect, since the first marks are located in the side of the recording start position for the thin plate member, in the sub-scanning direction, relative to the centering position of the mounting portion, the distance or amount of conveying the tray to the recording start position (search position) in the sub-scanning direction can be reduced. Therefore, the shifting of the center position of the thin plate member due to the skewing of the tray can be reduced or prevented.

In an eleventh aspect, the recording apparatus of the tenth aspect is featured in that the tray is provided with at least two third marks that are different in light reflectivity from the thin plate member and that are located at positions in the mounting portion to correspond to edge positions of the thin plate member mounted on the mounting portion. The third marks are arranged symmetrical to each other, in the sub-scanning direction, relative to the centering position of the mounting portion. Further, before the controller executes the sensing in the main scanning direction with the optical sensor, to obtain the center position of the thin plate member in the sub-scanning direction, the controller executes sensing in the sub-scanning direction with the optical sensor to detect boundary positions between the third marks and the thin plate member.

In this aspect, by the sensing in the sub-scanning direction with the optical sensor, the boundary positions between the third marks and the thin plate member are detected, to thereby directly obtain the center position of the thin plate member in the sub-scanning direction. Therefore, the sub-scanning center position of the thin plate member can be obtained accurately.

In a twelfth aspect, a recording apparatus includes: a carriage that has a recording head for recording on a recording medium and that is driven to reciprocate in a main scanning direction; a conveying roller that is disposed in an upstream side relative to the recording head in a conveying path along which the recording medium is to be conveyed, and that conveys the recording medium to a region opposite the recording head; and an optical sensor, provided on the carriage at a location opposite the conveying path, for detecting reflective change in the conveying path. The recording apparatus further includes: a carriage position detecting means for detecting position of the carriage in the main scanning direction; a conveying amount detecting means for detecting conveying amount of the recording medium by the conveying roller; and a controller into which detection information of the optical sensor, the carriage position detecting means and the conveying amount detecting means are respectively input, and that drives the carriage and the conveying roller in accordance with the input information. The recording apparatus is configured to be capable of conveying a tray including a plate-shaped tray main body capable of being conveyed by the conveying roller in the sub-scanning direction and a mounting portion which is formed in the tray main body and on which a thin plate member is mountable as a recording medium. The tray is configured according to any one of the fifth to seventh aspect. To obtain the center position of the mounting portion in the main scanning direction, the controller executes sensing in the main scanning direction with the optical sensor to detect edge positions of the second marks. Thereafter, the controller drives the conveying roller to position the recording head at the recording start position.

According to this aspect, since the second marks are located in the side of the recording start position for the thin plate member, in the sub-scanning direction, relative to the centering position of the mounting portion, the distance or amount of feeding the tray to the recording start position (search position) in the sub-scanning direction can be reduced. Therefore, the shifting of the center position of the thin plate member due to the skewing of the tray can be reduced or prevented.

In thirteenth aspect, the recording apparatus of the twelfth aspect is featured in that the tray is provided with at least two fourth marks that are different, in light reflectivity from the tray main body and that is located outside the mounting portion. The fourth marks are arranged symmetrical to each other, in the sub-scanning direction, relative to the centering position of the mounting portion. Before the controller executes the sensing in the main scanning direction with the optical sensor, to obtain the centering position of the mounting portion in the sub-scanning direction, the controller executes sensing in the sub-scanning direction with the optical sensor to detect edge positions of the fourth marks.

According to this aspect, by the sensing in the sub-scanning direction with the optical sensor, the edge positions of the fourth marks are detected, to thereby directly obtain the center position of the mounting portion in the sub-scanning direction. That is, the sub-scanning direction center position of the mounting portion can be accurately obtained

The present disclosure relates to the subject matter contained in Japanese patent application Nos. 2004-280715 (filed on Sep. 27, 2004) and 2005-251382 (filed on Aug. 31, 2005), each of which is expressly incorporated herein by reference in its entirety.

### BRIEF DESCRIPTION OF THE DRAWINGS

FIG. 1 is a schematic side cross-sectional view of an ink jet printer.

FIG. 2 is a side cross-sectional view of a tray conveying path according to one embodiment of the present invention.

FIG. 3 is a block diagram showing the controller of the ink jet printer.

FIG. 4 is a plan view of a tray according to the invention.

FIG. 5 is a plan view of the tray on which the sensing of positions and directions are performed by a PW sensor.

FIG. 6 is a flowchart showing the main routine of a centering position detection sequence.

FIG. 7 is a flowchart showing a sub-routine for the centering position detection sequence.

FIG. 8 is a flowchart showing a sub-routine for the centering position detection sequence.

FIG. 9 is a flowchart showing a sub-routine for the centering position detection sequence.

FIG. 10 is a flowchart showing a sub-routine for the centering position detection sequence.

FIG. 11 is a flowchart showing a sub-routine for the centering position detection sequence.

FIG. 12 is a flowchart showing a sub-routine for the centering position detection sequence.

FIGS. 13A and 13B are plan views of the forms of recording media that can be mounted on the tray according to the invention.

### DESCRIPTION OF THE PREFERRED EMBODIMENT

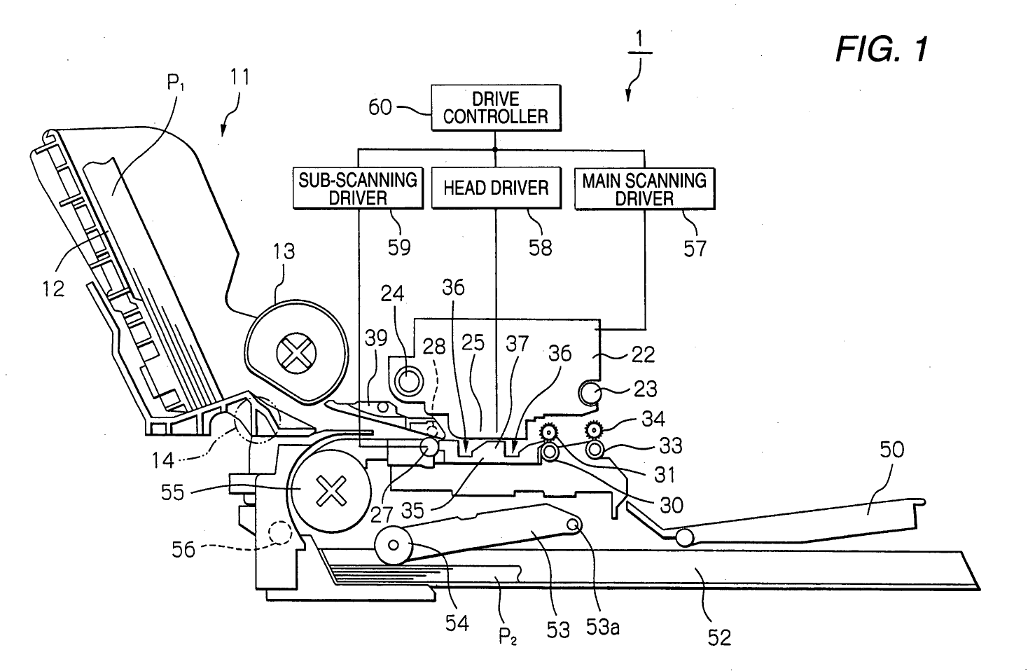

One embodiment of the present invention will now be described while referring to FIGS. 1 to 12.

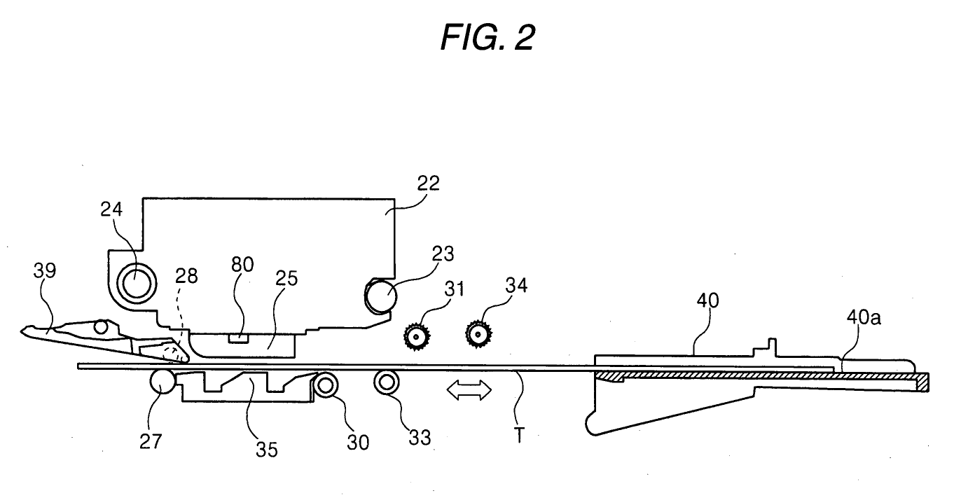

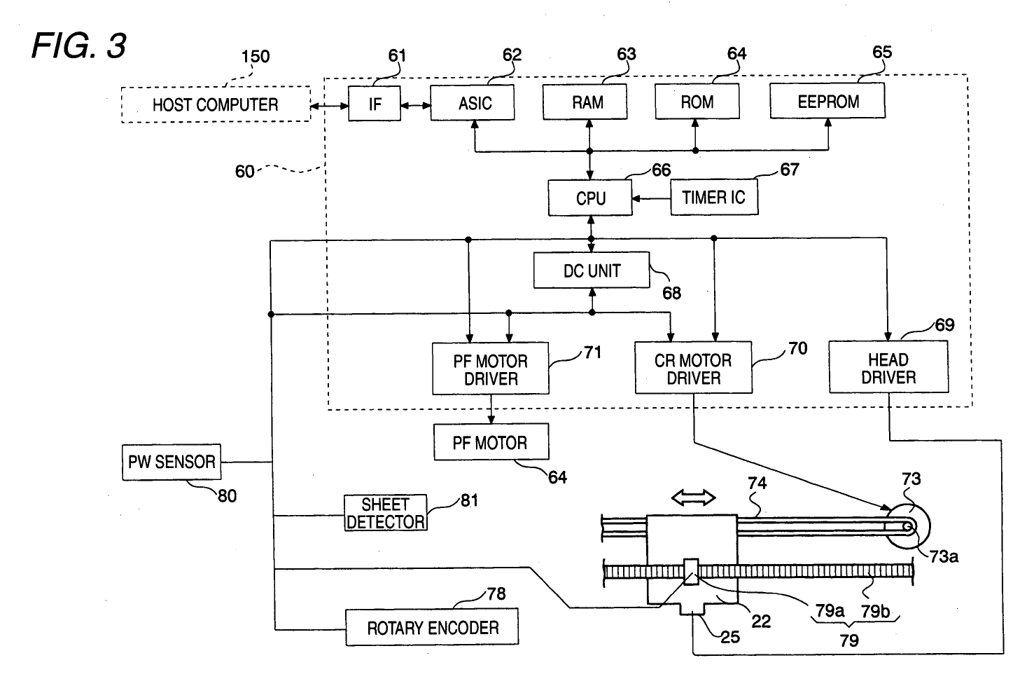

First, while referring to FIGS. 1 to 3, an explanation will be given for a general overview of the configuration of an ink jet printer (hereinafter referred to as a “printer”) 1 that serves as an example for a “recording apparatus” or a “liquid ejection apparatus”. FIG. 1 is a schematic side cross-sectional view of the printer 1, FIG. 2 is a side cross-sectional view of a conveying path for a tray T, and FIG. 3 is a block diagram mainly showing a drive controller 60.

In FIG. 1, in the printer 1, a feeder (ASF) 11, wherein sheets P1, which are example “recording media” or “ejection target media”, can be loaded and stacked at an angle, is located at the rear (to the left in FIG. 1) of the apparatus, and a sheet supply cassette 52, wherein sheets P2 are loaded horizontally, is arranged at the bottom of the apparatus. That is, the printer 1 includes two types of sheet feeding routes. Hereinafter, when the sheets P1 and P2 need not specifically be identified, they are referred to simply as the “sheets P”.

The feeder 11 includes a hopper 12, a feed roller 13 and a separation roller 14. The hopper 12 supports the sheets P1 in the angled posture, and is pivoted so as to being the sheets P1 into contact with the feed roller 13 or to separate the sheets P1 from the feed roller 13. The feed roller 13 is almost D shaped in side cross section, and when rotated, the topmost sheet P1 pressed against it is fed downstream. The separation roller 14, for which a predetermined rotation resistance force is provided, is so positioned that it can be pressed against the feed roller 13. When double feeding of the sheets P1 does not occur and only single sheets P1 are fed, the separation roller 14 is rotated in consonance with this feeding process. When, however, there is a plurality of sheets P1 between the feed roller 13 and the separation roller 14, the rotation of the separation roller 14 is halted because the coefficient of friction between the sheets P is low. Through this discriminating response by the separation roller 14, sheets P1 that would be double-fed following the topmost sheet P1 are not fed downstream from the feed roller 13, and are retained near the location whereat the feed roller 13 and the separation roller 14 press against each other. Thus, the double feeding of the sheets P1 can be prevented.

A conveying roller pair, consisting of a conveying drive roller 27 and a conveying driven roller 28, is located downstream of the feeder 11. The conveying drive roller 27, which has a long shaft, is extended in the main scanning direction and is rotated by a sub-scanning driver 59. That is, the sub-scanning driver 59 performs sub-scanning feeding of the sheet P (and of the tray T, which will be described later). The conveying driven roller 28 is supported rotatably by a plurality of driven roller holders 39 that are arranged in parallel in the main scanning direction, and is rotated, with the conveying drive roller 27, by being pressed against the conveying drive roller 27. A sheet P, supplied by the feeder 11 or from the sheet supply cassette 52 at the bottom of the apparatus, and the tray T, which will be described later, are nipped by the conveying drive roller 27 and the conveying driven roller 28 and are conveyed downstream by the rotation of the conveying drive roller 27.

Downstream of the conveying drive roller 27 and the conveying driven roller 28, an ink jet recording head 25 and a platen 35 are vertically arranged, facing each other. The ink jet recording head 25 is positioned at the bottom of a carriage 22, and ejects ink droplets onto the sheet P or a recording medium that will be described later, so that printing on the printing face of the sheet P or the recording medium is performed. The carriage 22 is guided in the main scanning direction by a main carriage guide shaft 24 and a sub-carriage guide shaft 23 that are extended in the main scanning direction (the direction toward the obverse and reverse surfaces of paper in FIG. 1), and is reciprocally moved in the main scanning direction by a main scanning driver 57. That is, the main scanning driver 57 performs main scanning of the ink jet recording head 25 (and a PW sensor 80 that will be described later). A head driver 58 drives the ink jet recording head 25 during the main scanning, and performs recording on the sheet P or on the recording medium.

According to the printer 1 in this embodiment, an ink cartridge is not mounted on the carriage 22, and is located at the front side bottom (not shown) of the apparatus, independent of the carriage 22. Ink is supplied from this ink cartridge through an ink supply tube (not shown) to the ink jet recording head 25.

In the platen 35, ribs. (not shown), each of which is extended both in the main scanning direction and in the sub scanning direction, are arranged at appropriate intervals in the main scanning direction, and support the sheet P and the tray T that will be described later. With this arrangement, the distance between the sheet P or the recording medium and the ink jet recording head 25 is determined. Further, a recessed portion 36 is formed in the surface of the platen 35 opposite the ink jet recording head 25 (ink nozzles).

An island portion 37 is present in the main scanning direction, partially in the recessed portion 86 that is formed and extended in the main scanning direction. With this structure, ink that is ejected outside the leading edge, the trailing edge and both sides of a sheet P of a predetermined size is disposed of in the recessed portion 36, and in this manner, marginless printing is performed. An ink absorption material (not shown) that absorbs disposed ink is provided for the recessed portion 36, and a hole (not shown) that communicates with the bottom of the platen 85 is formed in the bottom of the recessed portion 36, so that ink is guided (discharged) through the hole to a waste liquid collection tray that is located at the lower portion of the platen 35.

A first discharge drive roller 30, a second discharge driven roller 31, a second discharge drive roller 33 and a second discharge driven roller 34 are provided downstream of the ink jet recording head 25. The first discharge drive roller 31 and the second discharge drive roller 33 are rotated by a drive roller (not shown), and the first discharge driven roller 31 is rotated while in contact with the first discharge drive roller 30, and the second discharge driven roller 34 is rotated while in contact with the second discharge drive roller 33. A sheet P for which recording has been completed is nipped by these rollers and is discharged to a stacker 50.

A pickup roller 54 is located at the upper portion near the distal end of the sheet supply cassette 52 that is arranged at the bottom of the apparatus. The pickup roller 54 is supported by a support member 53, which is pivotable at a pivot shaft 53a, and is rotated by a drive motor (not shown). As the support member 53 is pivoted, the pickup roller 54 is displaced between the position where it contacts the sheets P2, which are stacked in the sheet supply cassette 52, and the position where it is separated from the sheets P2, and as it is rotated while in contact with the sheets P2, it feeds the topmost sheet P2 toward the rear (to the left in FIG. 1) of the apparatus.

A reverse roller 55, which is rotated by a drive motor (not shown), is provided near the distal end of the sheet supply cassette 52 and where for the sheets P2 a curved reverse path, consisting mainly of the reverse roller 55, is located. A nip roller 56 is located at a position opposite the reverse roller 55 and can be displaced between the position where it contacts the reverse roller 55 and the position where it is separated from the reverse roller 55. When the sheets P2 fed by the pickup roller 54 are passed through the point where the reverse roller 55 is pressed against the nip roller 56, double feeding is prevented, and the topmost sheet P2 is fed downstream by the exertion of a feeding force that is generated by the rotation of the reverse roller 55. The sheet P2 is conveyed along the curved reverse path, which consists mainly of the reverse roller 55, just as is a sheet P1 that is fed by the feeder 11, is nipped by the conveying drive roller 27 and the conveying driven roller 28, and is conveyed downstream.

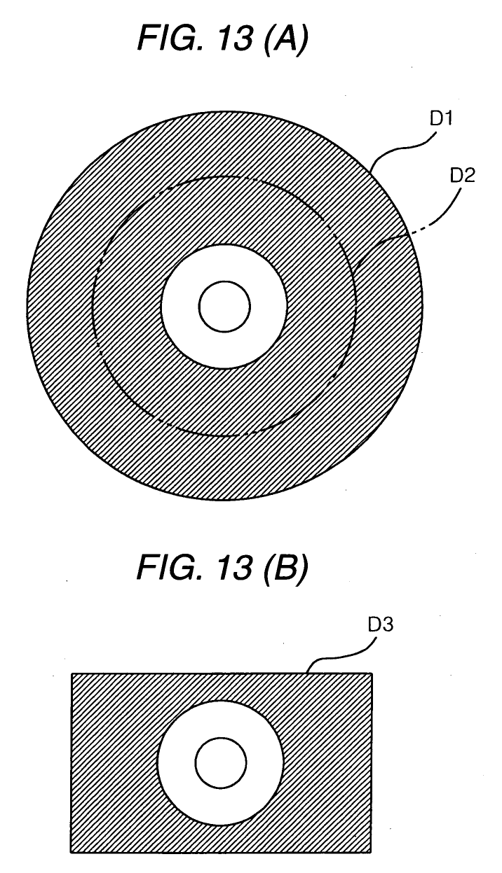

An explanation will now be given for the tray T on which optical disks D1, D2 and D3 (see FIG. 13; hereinafter these disks are generally called “recording media”), which are “recording materials” or “thin plate members”, can be mounted, and for associated tray T components that a not shown in FIG. 1.

As shown in FIG. 2, in the printer 1, a tray guide 40 is located downstream of the second discharge drive roller 33 and the second discharge driven roller 34. The tray guide 40 includes a tray support face 40a for supporting the tray T, and as shown in FIG. 2, can be switched between a position at which the tray T is guided from the tray support face 40a to the sheet conveying path and a position (not shown) whereto the tray T is retracted from the sheet conveying path.

The sheet conveying path is extended almost horizontally from the conveying drive roller 27 to the second discharge drive roller 33, and is also almost horizontal relative to the tray support face 40a. When the tray T is to be conveyed, as shown in FIG. 2, the first discharge driven roller 31 and the second discharge driven roller 34 are respectively separated from the first discharge drive roller 30 and the second discharge drive roller 33. Thus, when a data area is present immediately below the printing face of a recording medium, damage to the data area is prevented.

The tray T is manually fed from the front of the apparatus (downstream of the sheet conveying path: to the right in FIG. 2) to the rear of the apparatus (upstream of the sheet convoying path: to the left in FIG. 2), and is nipped by the conveying drive roller 27 and the conveying driven roller 28. Then, as the conveying drive roller 27 is rotated, the tray T is fed in a sub scanning direction indicated by an arrow in FIG. 2 (substantially in a horizontal direction in this embodiment). The PW sensor 80, will be described later in detail, is provided for the carriage 22 at a position opposite the tray T.

An explanation has been given for a general overview of the printer 1. In addition, a scanner unit (not shown) is mounted at the top of the printer 1, i.e., a printer 1 with a built-in scanner is provided for this embodiment, wherein the scanner reads an image that the above described recording means records. However, an explanation for the scanner unit is not given below.

Next, while referring to FIG. 3, an explanation will be given for the arrangement of a drive controller 60, which performs a predetermined recording method by controlling the main scanning driver 57, the head driver 58 and the sub-scanning driver 59 and its periphery. The drive controller 60 includes: an IF 61, which can exchange data with a host computer 150 that transmit, print information print data) to the printer 1 and that serves as an interface with the host computer 150; an ASIC 62; a RAM 63; a PROM 64 and an EEPROM 65; a CPU 66; a timer IC 67; a DC unit 68; a conveying motor (PF motor) driver 71; a carriage motor (CR motor) driver 70; and a head driver 69. Tho CPU 66 performs an operation to execute a control process for the printer 1 and other necessary operations, and the timer IC 67 generates cyclic interrupt signals required for various processes performed by the CPU 66. The ASIC 62 controls printing resolution and a waveform to drive the ink jet recording head 25 based on print data that are transmitted by the host computer 15 via the TF 61. The RAM 63 is used as a work area for the ASIC 62 and the CPU 66 or as the primary storage area for other data Various control programs (firmware) required to control the printer 1 and necessary data for the processing are stored in the PROM 64 and the EEPROM 65.

The DC unit 68 is a control circuit that controls the speed of DC motors (a CR motor 78 and a PF motor 64), and includes a PID controller, an acceleration controller and a PWM control circuit (none of them shown). Based on a control instruction transmitted by the CPU 66 and signals output by detection means, such as a rotary encoder 78, a linear encoder 79, a sheet detector 81, which detects the passage of the sheet P, and the PW sensor 80, the DC unit 68 performs various calculations to control the speeds of the DC motors, and transmits signals to the CR motor driver 70 and the PF motor driver 71.

Under the control of the DC unit 68, the PF motor driver 71 drives the PF motor 64. In this embodiment, the PF motor 64 rotates a plurality of targets, i.e., the feed roller 18, the conveying drive roller 27, the first discharge drive roller 30 and the second discharge drive roller 33 described above.

Whereas the CR motor driver 70, under the control of the DC unit 68, drives the CR motor 73 to reciprocally move the carriage 22 in the main scanning direction; or to halt and hold the carriage 22, the head driver 69,under the control of the CPU 66, drives the ink jet recording head 25 in accordance with print data received from the host computer 150.

The CPU 66 and the DC unit 68 receive a detection signal from the sheet detector 81, which detects the leading edge and the trailing edge of a sheet P that is conveyed, a signal output by the rotary encoder 78, which detects the rotational distance, the rotational direction and the rotational velocity of the PF motor 64, and a signal output by the linear encoder 79, which detects the absolute position of the carriage 22 in the main scanning direction. The CPU 66 and the DC unit 68 also receive a signal from the PW sensor 80.

As shown in FIG. 2, the PW sensor 80 is an optical sensor, located at the bottom of the carriage 22, and includes: a light-emitting portion (not shown), which emits light to irradiate a sheet P or the tray T; and a light-receiving portion (not shown), which receives light reflected by the sheet P or the tray T. As the carriage 22 is scanned, the PW sensor 80 detects the presence or absence of a sheet P or the width of a sheet P, and as will also be described later, detects marks provided for the tray T in order to identify the centering position for the recording medium mounting area or the tray T. Further, the PW sensor 80 detects the edge position of a recording medium that is mounted on the tray T and identifies the centering position for the recording medium. Based on information for the thus detected centering position, the positioning of a printing area is performed.

The rotary encoder 78 includes: a disk-shaped scale (not shown) having multiple light-transmitting portions along its circumference; and a detection section (not shown) having a light-emitting portion that emits light to irradiate the light-transmitting portions and a light-receiving portion that receives light that has passed through the light-transmitting portions. As the disk-shaped scale is rotated, the detection section outputs a rising signal and a falling signal that are formed by light that has passed through the light-transmitting portions. Based on these signals received from the rotary encoder 78, the drive controller 60 detects the rotational distance, the rotational velocity and the rotational direction, for example, of the conveying drive roller 27, and can control the feeding (the sub-scanning feeding) of a target sheet P or the tray T.

The linear encoder 79 includes: an encoding plate 79b, which is elongated in the main scanning direction; and a detection section 79a, which has a light-emitting portion that emits light to irradiate a plurality of light-transmitting portions formed in the encoding plate 79b in the main scanning direction, and a light-receiving portion that receives light that has passed through the light-transmitting portions. The detection section 79a outputs a rising signal and a falling signal that are formed by light that has passed through the light-transmitting portions, and the drive controller 60 receives these signals from the detection signal 79a and detects the position of the carriage 22 (i.e., the PW sensor 80) in the main scanning direction.

It should be noted that the PF motor driver 71 and the PF motor 64 constitute the sub-scanning driver 59 in FIG. 1, the CR motor driver 70 and the CR motor 73 constitute the main scanning driver 57, and the head driver 69 constitutes the head driver 58.

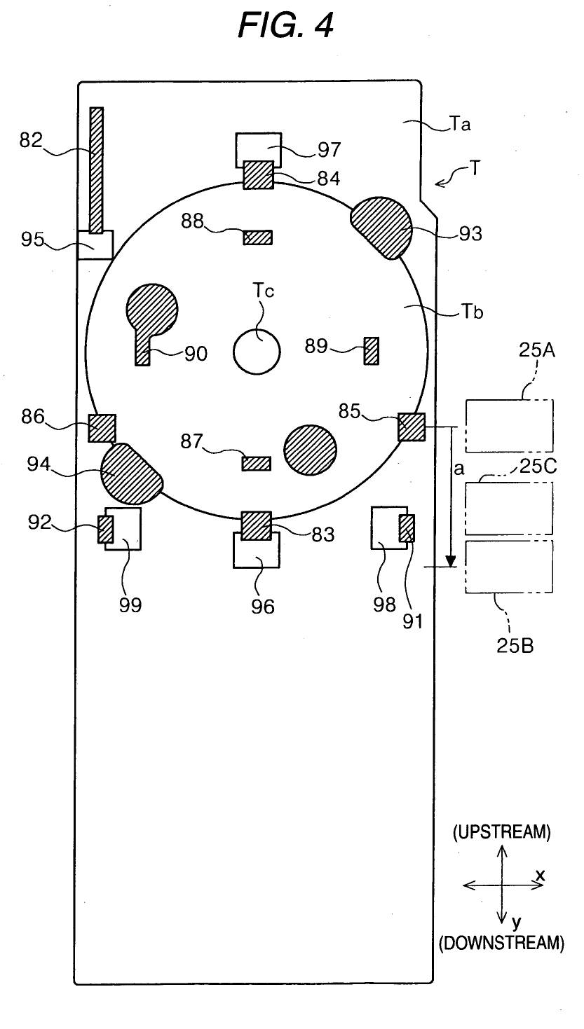

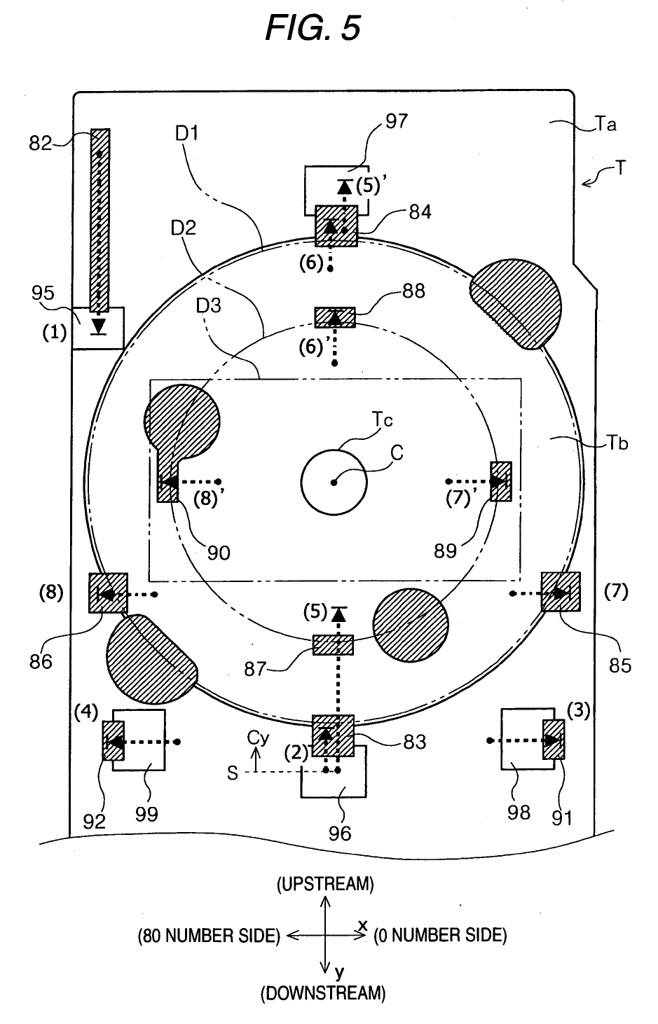

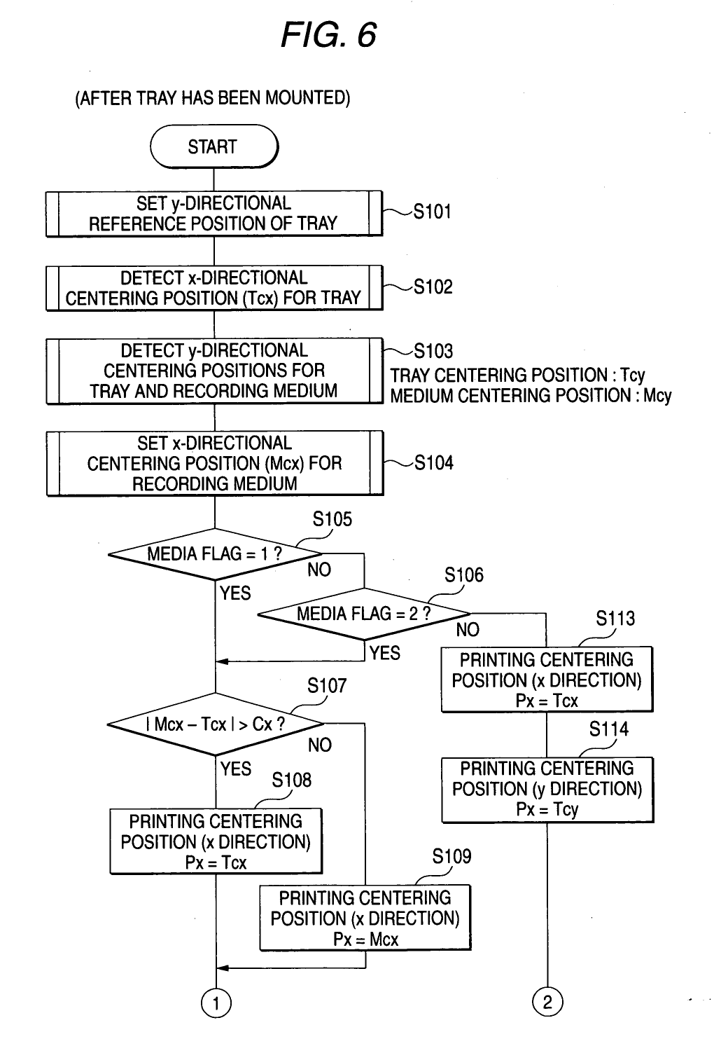

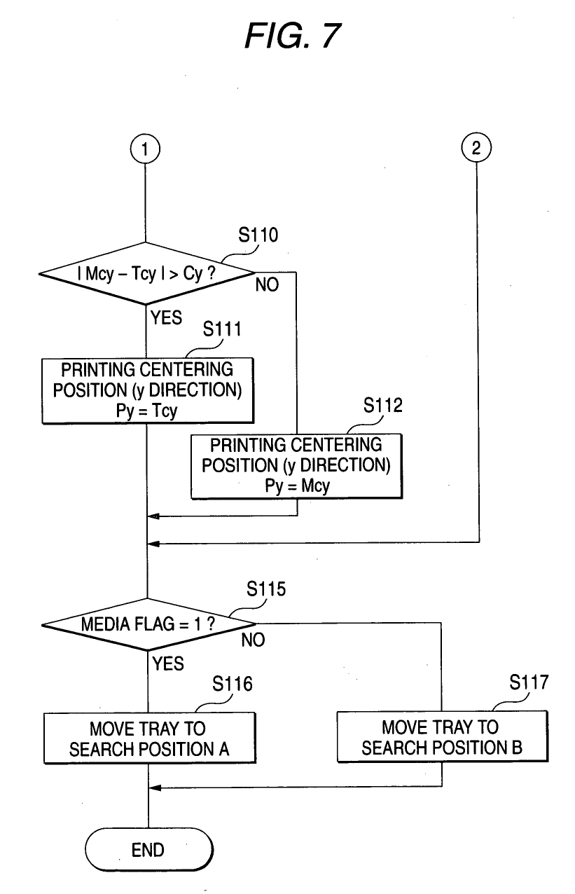

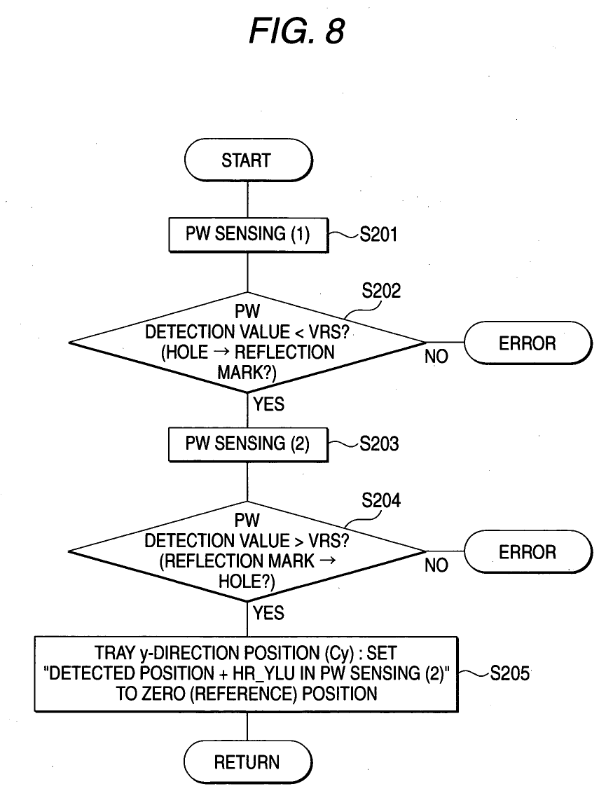

While referring to FIGS. 4 to 12, a detailed explanation will now be given for the arrangement of the tray T, for a mounting portion Tb formed in the tray T, and for a method for detecting the centering position for a recording medium mounted on the mounting portion Tb. FIG. 4 is a plan view of the tray T and FIG. 5 is a plan view that shows sensing positions for the PW sensor 80 and sensing directions. FIGS. 6 and 7 are flowcharts showing the contents of the main routine or the centering position detection sequence. And FIGS. 8 to 12 are flowcharts showing the contents of the sub-routines for the centering position detection sequence. FIGS. 13A and 13B are plan views of the forms of thin plate members that can be mounted on the tray T. In FIGS. 4 and 5, the vertical direction in the drawing is the sub-scanning direction (the y direction), while towards the top is upstream along the sheet conveying path, and towards the bottom is downstream along the sheet conveying path. The transverse direction in the drawing indicates the main scanning direction (the x direction), while to the right in the drawing indicates the direction in which the number 0 is approached, and to the left in the drawing indicates the direction in which the number 80 is approached.

As shown in FIG. 4, the tray T includes: a tray main body Ta, which is shaped like a plate so as to be nipped by the conveying drive roller 27 and the conveying driven roller 28, i.e., to be fed in the sub-scanning direction; and the mounting portion Tb, which is formed in the tray main body Ta and on which a recording medium can be mounted. The mounting portion Tb is a recessed portion having a symmetric shape in the sub-scanning direction and in the main scanning direction in the plan view shown in FIG. 4, i.e., having a circular shape, and a projection Tc is formed in the center of the mounting portion Tb.

In this embodiment, recording media that can be mounted on the mounting portion Tb are the disk-shaped recording media D1 and D2, as shown in FIG. 13A, and the card-shaped recording medium D3, as shown in FIG. 18B. These recording media have a hole in the center, and when those holes are fitted onto the projection Tc formed in the mounting portion Tb, the positions of the recording media in the mounting portion Tb are determined. In this embodiment, the recording medium D1 is a 12-cm disk, the recording medium D2 is an 8-cm disk, and the recording medium D3 has a name card size. The shaded portions in FIG. 13 represent printing available areas.

Referring again to FIG. 4, two ejection holes 93 and 94 are formed in the mounting portion Tb with the projection Tc between them, so that these holes 93 and 94 are located in a straight line across the center of the mounting portion Tb. With this arrangement, a recording medium (especially the 12-cm recording medium D1) can be easily extracted from the mounting portion Tb. The shaded portions in FIG. 4 represent through holes.

Next, an explanation will be given for holes 82 to 92, which can be detected by the PW sensor 80, and reflection marks 95 to 99.

As shown in FIG. 4, the holes 82 to 92 are square and rectangular holes in the plan view, and the reflection marks 95 to 99 have square shapes with a color that represents a different light reflectivity relative to the tray main body Ta. In this embodiment, the tray main body Ta and the mounting portion Tb are black, and the reflection marks 95 to 99 are white. When the PW sensor 80 is opposite one of the holes 82 to 92, light emitted by the PW sensor 80 is projected onto the platen 35 through the holes 82 to 92 and is reflected. The reflectivity of this light differs among the tray main body Ta, the mounting portion Tb and the recording medium. Therefore, when an arbitrary two of the tray main body Ta, the mounting portion Tb, the holes 82 to 92 and the recording medium are located adjacent to each other, the boundary position can be accurately detected by the PW sensor 80.

It should be noted that the holes 85 and 86 function as “first marks” and the holes 91 and 92 and the reflection marks 98 and 99 function as “second marks”. Also, the holes 83 and 84 or the holes 87 and 88 function as “third marks”, and the holes 83 and 84 and the reflection marks 96 and 97 function as “fourth marks” (details will be given later).

An explanation will now be given for the method for detecting the centering position for the mounting portion Tb and the centering position for the recording medium, together with the positions of the holes 82 to 92 and the reflection marks 95 to 99 relative to the tray T, and the functions of the holes 82 and 92 and the reflection marks 95 to 99.

First, in FIG. 6, when the tray T whereon a recording medium is mounted in the mounting portion Tb is inserted into the printer 1, and when an instruction to feed the tray T is issued, the drive controller 60 of the printer 1 sequentially performs the setup of the y directional reference position for the tray T (step S101), the detection of the x-directional centering position for the mounting portion Tb (step S102), the detection of the y-directional centering positions for the mounting portion Tb and the recording medium (step S103), and the detection of the x-directional centering position for the recording medium (step S104). Thereafter, the drive controller 60 feeds the tray T in the sub-scanning direction to a recording start position (search position).

That is, in this embodiment, the centering position (denoted by symbol C in FIG. 5) of the recording medium is directly detected by detecting the edge of the recording medium, and the centering position (denoted by symbol C in FIG. 5) for the mounting portion Tb is also detected. Thus, even when the detection of the centering position for the recording medium fails the detection of the centering position for of the mounting portion Tb is performed, and the detected centering position is employed to set a printing range. As a result, printing can be performed without noticeable printing position shift. As is apparent from FIG. 5, when both the mounting portion Tb and the recording medium are accurately formed, and when the recording medium is correctly mounted on the mounting portion Tb, the position C is the centering position for the two, i.e.; the centering positions match (the theoretical centering position).

The detailed processes at steps S101 to S104 in FIG. 6 will now be described.

FIG. 8 is a flowchart showing the processing for obtaining the reference position (zero position) of the directional position (Cy) for the tray T. At step S201 in FIG. 8, the PW sensor 80 performs a sensing process (1). The position and direction for this sensing process (1) are indicated by (1) in FIG. 5, and the drive controller 60 of the printer 1 drives the carriage 22 and feeds the tray T in the sub-scanning direction, so that the PW sensor 80 can perform the sensing process for the position, and in the direction, as indicated by (1) in FIG. 5.

It should be noted, however, that even when the carriage 22 is driven and the tray T is fed in the sub-scanning direction to perform the sensing shown in FIG. 5, the target sensing process is not always able to be performed (e.g., when the tray T is not correctly mounted). In this case, in this embodiment, it is assumed that an error has occurred, and the centering position detection process is halted and the tray T is discharged.

The hole 82, which is detected during the sensing process (1), is located at the end of the tray T near the number 80, upstream along the sheet conveying path, and is extended in the sub-scanning feeding direction. The reflection mark 95 is provided, adjacent to the hole 82, at the downstream end. The general position (the position in the main scanning direction and in the sub-scanning direction) of the hole 82 is stored in advance, and when the tray T has been manually inserted, the PW sensor 80 is moved to face the hole 82 by moving the carriage 22 and by feeding the tray T in the sub-scanning direction.

Then, a check is performed to determine whether the detection value of the PW sensor 80 during the sensing process (1) is smaller than VRS (a change that occurs when the PW sensor 80 is moved from the hole to the reflection mark) (step S202). In accordance with the results, the position of the boundary between the hole S2 and the reflection mark 95 can be obtained.

Based on the detection results, the tray T is fed in the sub-scanning direction, and at step S203, a sensing process (2) in FIG. 5 is performed. The hole 83, which is detected during the sensing process (2), is located at the edge position of the recording medium D1 when it is mounted on the mounting portion Tb, and is positioned at the center of the mounting portion Tb in the main scanning direction and is positioned downstream of the mounting portion Tb in the sub-scanning direction. The reflection mark 96 is provided adjacent to the hole 83 and downstream of the hole 83.

A check is performed to determine whether the detection value for the PW sensor 80 obtained during the sensing process (2) is greater than VRS (a change when the PW sensor 80 is shifted from the reflection mark to the hole) (step S204). In accordance with the results, the position of the boundary between the hole 83 and the reflection mark 96 can be obtained.

And a variable Cy that represents the y-directional position of the tray T is set to the detection position+HR_YLU during the sensing process (2) (step S205). In this case, HR_YLU is a predesignated constant. In this embodiment, the position Cy=0 is substantially a position denoted by symbol S in FIG. 5, and from this position toward upstream, the variable Cy is incremented:

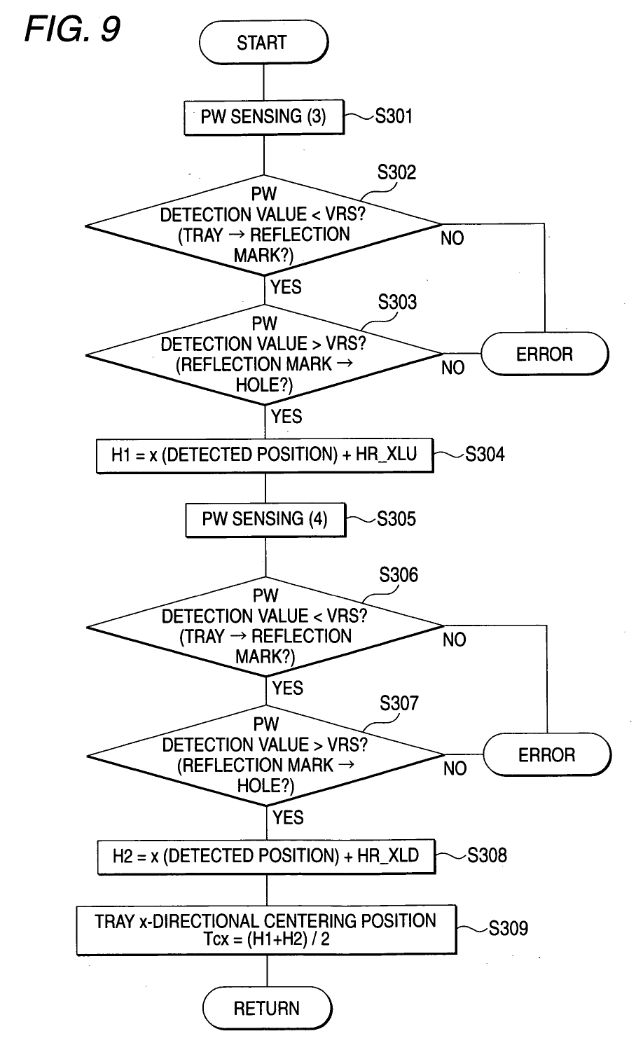

FIG. 9 is a flowchart showing the processing for obtaining the x-directional centering position (Tcx) for the mounting portion Tb in the tray T. First, at step S301, a sensing process (3) in FIG. 5 is performed. As for the main scanning direction, the holes 91 and 92 are located at positions symmetrical to the centering position C for the mounting portion Tb in the main scanning direction, and as for the sub-scanning direction, are located nearer the recording start position (lower portion in FIG. 4) than the centering position for the mounting portion Tb. The reflection marks 98 and 99 are provided inside the holes 91 and 92 (inside the tray T), adjacent to the respective holes.

A check is performed to determine whether the detection value the PW sensor 80 obtained during the sensing process (3) is smaller than the VRS (a change when the PW sensor 80 is shifted from the tray to the reflection mark) (step S302). Further, a check is performed to determine whether the value is thereafter greater than the VRS (a change when the PW sensor 80 is shifted from the reflection mark to the hole) (step S303). A variable II1 that represents the positions of the hole 91 and the reflection mark 98 in the main scanning direction are set to the x (detected position)+HR_XLU (step S304). In this case, IIR_XLU is a predesignated constant.

Sequentially, at step S305, a sensing process (4) in FIG. 5 is performed, and a check is performed to determine whether the detection value the PW sensor 80 obtained is smaller than VRS (a change when the PW sensor 80 is shifted from the tray to the reflection mark) (step S306). Furthermore, a check is performed to determine whether the detection value is thereafter greater than VRS (a change when the PW sensor 80 is shifted from the reflection mark to the hole) (step S807). A variable H2 that represents the positions of the hole 92 and the reflection mark 99 in the main scanning direction is set to x (detected position)+HR+XLD (step S308). In this case, HR_XLD is a predesignated constant, and in this embodiment, the same value as HR_XLU (step S304) is employed. However, for example, a different value may be employed in order to correct a detection error due to the characteristics of the PW sensor 80, i.e., an offset variable may be employed.

The variables H1 and H2 that are thus obtained are added together and the sum is divided by two, so that the x-directional centering position (Tcx) for the tray T, i.e., mounting portion Tb, can be obtained (step S309).

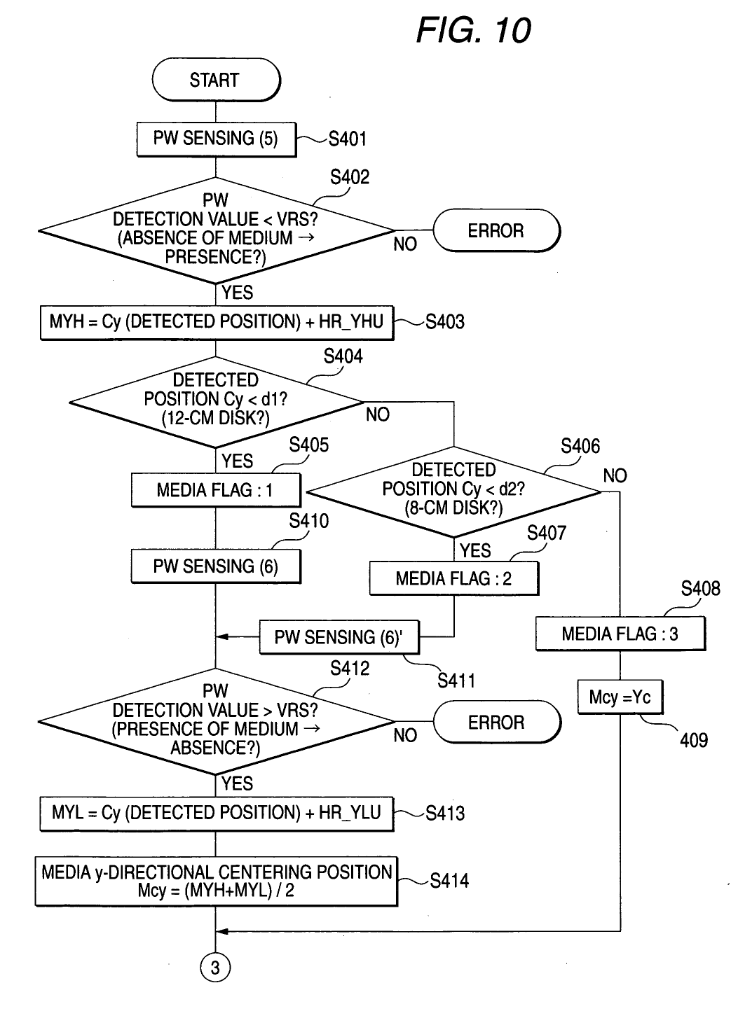

FIG. 10 is a flowchart showing the processing for obtaining the y-directional centering position (Tcy) for the mounting portion Tb in the tray T and the y-directional centering position (Mcy) for the recording medium. Fist, at step S401, a sensing process (5) in FIG. 5 is performed In this case, an imaginary line denoted by D1 in FIG. 5 indicates the edge of the recording medium D1 (a 12-cm disk) in FIG. 13 that is mounted on the mounting portion Tb. Similarly, an imaginary line D2 indicates the edge of the recording medium D2 (8-cm disk) mounted on the mounting portion Tb, and an imaginary line D2 indicates the edge of the recording medium D3 (name card sized) mounted on the mounting portion Tb.

The hole 87 that can be detected during the sensing process (5) is located at a position corresponding to the edge position of the recording medium D2, and at the center of the mounting portion Tb in the main scanning direction, or downstream of the mounting portion Tb in the sub-scanning direction. A check is performed to determine whether the detection value the PW sensor 80 obtained during the sensing process (5) is smaller than VRS (a change when the PW sensor 80 is shifted from a position other than the recording medium to the recording medium) (step S402). A variable MYH that represents the edge position of the recording medium (a position downstream in the sub-scanning direction: a position near the hole 83 or 87) is set to Cy (detected position)+IIR_YHU (step S403). In this case, HR_YHU is a predesignated constant, and in this embodiment, the same value as IIR_YLU at step S205 in FIG. 8 is employed. However, for example, a different value may be employed in order to correct a detection error due to the characteristics of the PW sensor 80, i.e., an offset variable may be employed.

In a case where the recording medium D1 is mounted on the mounting portion Tb, a boundary position between the hole 88 and the recording medium D1 can be detected. In a case where the recording medium D2 is mounted on the mounting portion Tb, a boundary position between the hole 87 and the recoding medium D2 can be detected.

Following this, at step S404, a check is performed to determine whether the detected position Cy is smaller than a predetermined value d1, i.e., whether the detected position Cy indicates the edge position of a 12-cm disk. When the detected position Cy indicates the edge position of a 12-cm disk (affirmative), “1” is set for a media flag that represents the type of recording medium (step S405). When the detected position Cy does not indicate the edge position of a 12-cm disk (negative), a check is performed to determine whether the detected position Cy is smaller than a predetermined value d2, i.e., indicates the edge position of an 8-cm disk (step S406). When the detected position Cy indicates the edge position of an 8-cm disk (affirmative), “2” is set for the media flag (step S407). When the detected position Cy indicates the edge position for a disk other than an 8-cm disk (negative), “3” is set for the media flag (step S408: it is determined that the recording medium D3 in FIG. 13 is mounted).

Sequentially, when the media flag is “1”, a sensing process (6) in FIG. 5 is performed at step S410, and a check is performed to determine whether the detection value the PW sensor 80 obtained is greater than VRS (a change when the PW sensor 80 is shifted from the recording medium to a portion other than the recording medium) (step S412). Then, a variable MYL that represents the edge position (the position upstream in the sub-scanning direction: the position near the hole 84) of the recording medium (a 12-cm disk in this case) is set to Cy (detected position)+HR_YLU (step S413). Tho hole 84 detected during the sensing process (6) is located at the edge position of the recording medium D1 when it is mounted on the mounting portion Tb, and is positioned at the center of the mounting portion Tb in the main scanning direction, or is positioned upstream of the mounting portion Tb in the sub-scanning direction. The reflection mark 97 is provided upstream of and adjacent to the hole 84.

When the media flag indicates “2”, a sensing process (6) in FIG. 5 is performed at step S411, and a check is performed to determine whether the detection value tho PW sensor 80 obtained is greater than VRS (a change when the PW sensor 80 is shifted from the recording medium to a portion other than the recording medium) (step S412). Then, the variable MYL that represents the edge position (the position upstream in the sub-scanning direction: the position near the hole 88) of the recording medium (an 8-cm disk in this case) is set to Cy (detected position)+HR_YLU step S413). The hole detected during the sensing process (6) is located so that it corresponds to the edge position of the recording medium D2, and is positioned at the center of the mounting portion Tb in the main scanning direction, or positioned upstream of the mounting portion Tb in the sub-scanning direction.

The variables MYH and MYL that are thus obtained are added together and the sum is divided by two, so that the y-directional centering position (Mcy) for the recording medium can be obtained (step S414).

When “3” is set for the media flag at step S408, predetermined value Yc is set for the y-directional centering position Mcy for the recording medium (step S409). The predetermined value Yc is a predesignated value that is a distance from the position Cy=0 (a position S in FIG. 5) to the centering position C for the mounting portion Tb. Therefore, when the media flag indicates “3”, instead of detecting the edge of the recording medium and setting the edge directly for the y-directional centering position, the position Cy is obtained by using the tray T as a reference i.e., the tray T is employed as a reference to set the y-directional centering position.

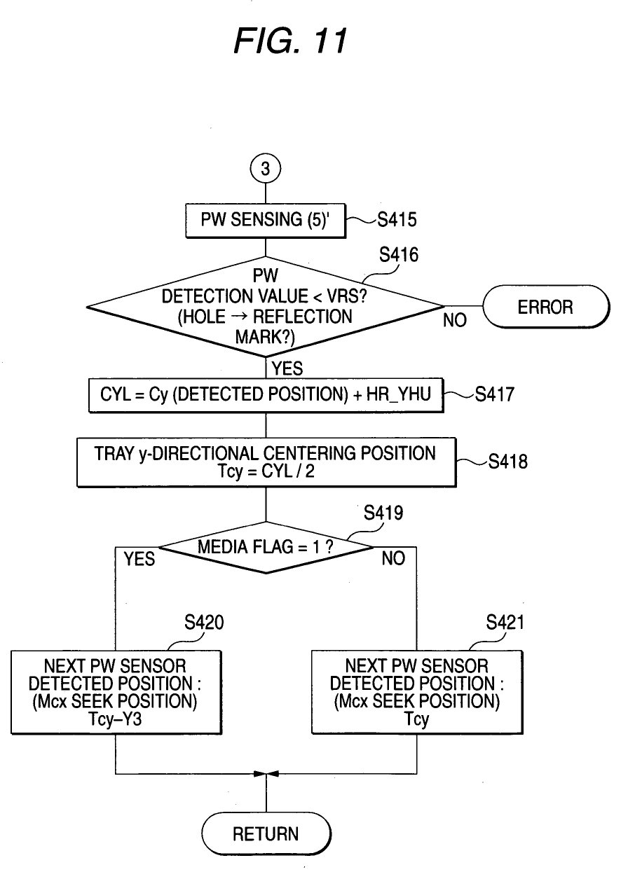

Following this, referring to FIG. 11, a sensing process (5)′ in FIG. 5 is performed at step S415, and a check is performed to determine whether the detection value the PW sensor 80 obtained is smaller than VRS (a change when the PW sensor 80 is shifted from the hole to the reflection mark) (step S416). A variable CYL, representing a position (a position near the reflection mark 97) that is symmetrical to the position Cy=0 (the position denoted by S) relative to the centering position C in the sub-scanning direction, is set to Cy (detected position)+HR_YHU (step S417). This variable CYL is divided by two, so that the centering position (Tcy) for of the mounting portion Tb in the sub-scanning direction can be obtained (step S418).

Next, a check is performed to determine whether the media flag indicates “1” (a 12-cm disk or not) (step S419). When the media flag indicates “1” (affirmative), the next detected position of the PW sensor 80 (the position of the tray T in the sub-scanning direction when the centering position Mcx of the recording medium in the main scanning direction is to be sought) is set to Tcy Y3 (Y3: predetermined value) (the position for performing sensing processes (7) and (8) in FIG. 5: step S420). When the media flag indicates a value other than “1” (negative), the detected position of the PW sensor 80 is set to Tcy (positions to perform sensing processes (7)′ and (8)′ in FIG. 5: step S421), and necessary sub-scanning feeding is performed.

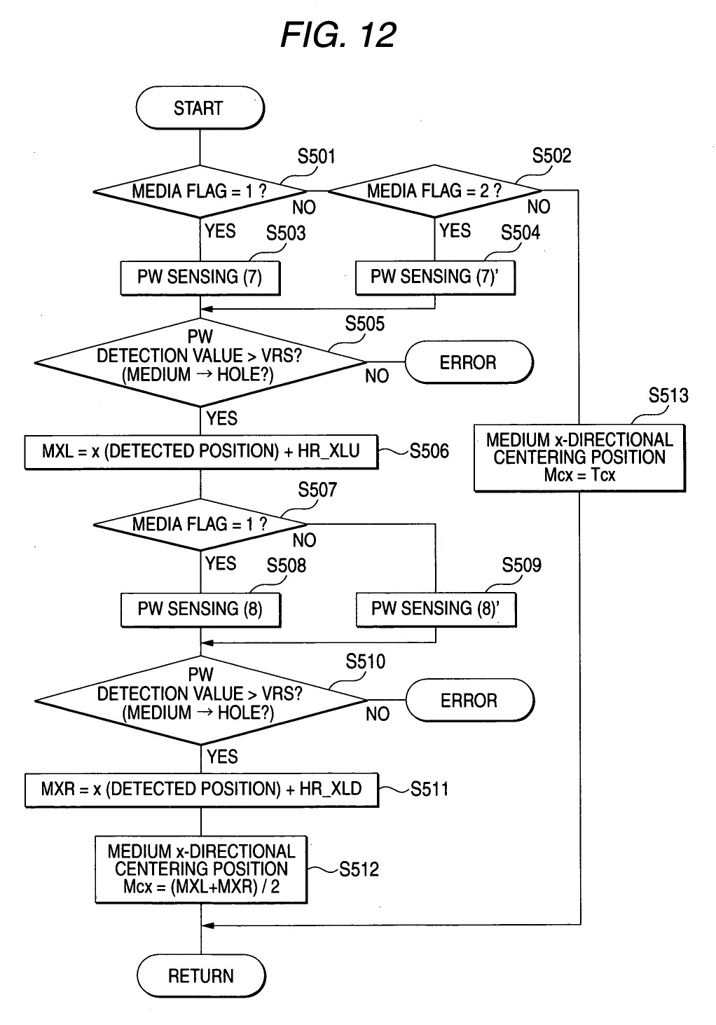

FIG. 12 is a flowchart showing the processing for obtaining the x-directional centering position (Mcx) for the recording medium. First, at step S501, a check is performed to determine whether the media flag indicates “1”. When the media flag indicates “1” (a 12-cm disk), the sensing process (7) in FIG. 5 is performed (step S508). The holes 85 and 86, which are the “first marks” to be detected during the sensing processes (7) and (8), are located at positions corresponding to the edge positions of the recording medium D1. Further, as for the main scanning direction, the holes 85 and 86 are symmetrically positioned relative to the centering position C of the mounting portion Tb in the main scanning direction, and as for the sub-scanning direction, are arranged near the recording start position (downstream) for the recording medium D1 relative to the centering position C for the mounting portion Tb in the sub-scanning direction.

A check is performed to determine whether the detection value the PW sensor 80 obtained during the sensing process (7) is greater than VRS (a change when the PW sensor 80 is shifted from the recording medium to the hole) (step S505). Then, a variable MXL that represents the edge position of the recording medium (the position in the main scanning direction: the position near the hole 85) is set to Cy (detected position)+HR_XLU (step S506).

When the media flag does not indicates “1” (negative at step S501), at step S502 a check is performed to determine whether the media flag indicates “2”. When the media flag indicates “2” (8-cm disk), the sensing process (7)′ in FIG. 5 is performed (step S504). A check is performed to determine whether the detection value the PW sensor 80 obtained during the sensing process (7)′ is greater than VRS (a change when the PW sensor 80 is shifted from the recording medium to the hole) (step S505). Then, a variable MXL that represents the edge position (the position in the main scanning direction: the position near the hole 89) is set to Cy (detected position)+HR_XLU (step S506).

Sequentially, when the media flag indicates “1” (affirmative at step S507), the sensing process (8) in FIG. 5 is performed (step S508). A check is then performed to determine whether the detection value the PW sensor 80 obtained during the sensing process (8) is greater than VRS (a change when the PW sensor 80 is shifted from the recording medium to the hole) (step S510). A variable MXR that represents the edge position of the recording medium (the position in the main scanning direction: the position near the hole 86) is set to Cy (detected position)+IIR_XLD (step S511).

When the media flag indicates “2” (negative at step S507), the sensing process (8)′ in FIG. 5 is performed (step S509). A check is performed to determine whether the detection value the PW sensor 80 obtained during the sensing process (8)′ is greater than VRS (a change when the PW sensor 80 is shifted from the recording medium to the hole) (step S510). A variable that represents the edge position of the recording medium (the position in the main scanning direction: the position near the hole 90) is set to Cy (detected position)+HR_XLD (step S511).

The variables MXL and MXR that are thus obtained are added together and the sum is divided by two, to that the x-directional centering position (Mcx) for the recording medium can be obtained (step S512).

When the media flag does not indicate either “1” or “2” (negative at step S502: the media flag is “3”), the x-directional centering position for the recording medium is set to Tcx, which is the x-directional centering position for the mounting portion Tb that has already been obtained (step S513). Therefore, when the media flag is “3”, instead of detecting the edge of the recording medium and setting the edge directly for the x-directional centering position, Tcx is obtained by using the tray T as a reference, i.e., the tray T is employed as a reference to set the x-directional centering position.

Sequentially, referring back to the main routine in FIG. 6, at steps S105 and S106, a check is performed to determine whether the media flag indicates “1” and further whether it indicates “2”. When the media flag indicates “1” or “2” (a 12-cm disk or an 8-cm disk), a check is performed to determine a difference between Mcx (a value employing the recording medium as a reference), which represents the x-directional centering position obtained by detecting the edge of the recording medium, and Tcx (a value obtained by employing the tray T as a reference), which represents the x-directional centering position obtained by detecting the holes 91 and 92 and the reflection marks 98 and 99 provided for the tray T, is greater than a permissible value Cx (step S107). When the difference is smaller than the permissible value Cx (negative), an x-directional printing centering position Px is set to Mcx (a value obtained by employing the recording medium as a reference) (step S109). When the difference is greater than the permissible value Cx (affirmative), it is ascertained that the edge position of the recording medium can not be properly detected and the x-directional printing centering position Px is set to Tcx (a value for which the tray T is employed as a reference) (step S108).

Similarly, as shown in FIG. 7, a check is performed to determine whether a difference between Mcy (a value for which the recording medium is employed as a reference), which represents the y-directional centering position obtained by detecting the edge of the recording medium, and Tcy (a value for which the tray T is employed as a reference), which represents the y-directional centering position obtained by detecting the holes 83 and 84 and the reflection marks 96 and 97 provided for the tray T, is greater than a permissible value Cy (step S110). When the difference is smaller than the permissible value Cy (negative), a y-directional printing centering position Py is set to Mcy (a value for which the recording medium is employed as a reference) (step S112). When the difference is greater than the permissible value Cy (affirmative), it is ascertained that the edge of the recording medium can not be properly detected and the y-directional printing centering position Py is set to Tcy (a value for which the tray T is employed as a reference) (step S111).

Referring again to FIG. 6, when it is determined at step S106 that the media flag indicates “3” negative), the x-directional printing centering position Px is set to Tcx, which is a value obtained unconditionally by using the tray T as a reference (step S113), and the y-directional printing centering position Py is set to Tcy (step S114). As a result, when a recording medium has such a shape, like the recording medium D3, that accurate edge detection is difficult, a printing position shift due to the incorrect detection of the centering position can be prevented.

Following this, at step S115 in FIG. 7, a check is performed to determine whether the media flag indicates “1”. When the media flag indicates “1” (a 12-cm disk), the tray T is moved to a search position A by sub-scanning feeding (step S116). When the media flag indicates a value other than “1” (an 8-cm disk or a recording medium of a name card size), the tray T is moved to a search position B by sub-scanning feeding (step S117).

A position 25B in FIG. 4 is the position of the ink jet recording head 25 relative to the tray T at the search position A. A position 25C is the position of the ink jet recording head 25 relative to the tray T at the search position B. That is, in FIG. 4 (and FIG. 5), the lower portion of the protrusion Tc is the recording start position side of the recording medium.

A position 25A in FIG. 4 is the position of the ink jet recording head 25 relative to the tray T before it is fed to the search position A when the media flag indicates “1” (a 12-cm disk). That is, the positional relationship (the positional relationship in, the sub-scanning direction) between the tray T and the ink jet recording head 25 is shown by detecting the edge position of the recording medium in FIG. 12 and by obtaining the x-directional centering position for of the recording medium. Therefore, at step S116 in FIG. 7, the tray T is fed in the sub-scanning direction a distance a in FIG. 4.

Through the processing described above, the following effects can be obtained. At least two first marks (holes 85 and 86) having different light reflectivities relative to the recording medium are provided at positions corresponding to the edge position of the recording medium that is mounted on the mounting portion Tb of the tray T. As for the main scanning direction, the first marks (holes 85 and 86) are located at positions symmetrical to the centering position for the mounting portion Tb in the main scanning direction, and as for the sub-scanning direction, are located near the recording start position (the lower portion in FIG. 4) of the recording medium relative to the centering position C for the mounting portion Tb in the sub-scanning direction. Thus, when the PW sensor 80 reads the first marks (holes 85 and 86), the centering position (Mxc) for the recording medium in the main scanning direction can be obtained since, as for the sub-scanning direction, the first marks are located near the recording start position of the recording medium relative to the centering position C of the mounting portion Tb in the sub-scanning direction, the sub-scanning feeding distance (denoted by a in FIG. 4) whereat the tray T is moved to the search position after the first marks have been read can be shortened. Therefore, the shifting of the centering position for the recording medium due to the skewed feeding of the tray T can be reduced, or prevented.

The shifting of the centering position for the recording medium due to the skewed feeding of the tray T tends to more greatly affect the centering position in the main scanning direction than the centering position in the sub scanning direction. Therefore, in the printer 1 of the embodiment, the prevention of the shifting of the centering position in the main scanning direction due to the skewed feeding of the tray T is regarded as having the highest priority. Thus, as described above, in the centering position detection sequence in FIG. 6, the detection of be x-directional centering-position (Mcx), by employing the edge position of the recording medium as a reference, is performed last (step S104), and thereafter, the tray T is moved to the search position by sub-scanning feeding, i.e., the sub-scanning feeding distance for the tray T is minimized

According to the embodiment, the first marks (holes 85 and 86) used to detect the edge position of a 12-cm disk are located near the recording start position of the recording medium relative to the centering position C of the mounting portion Tb in the sub-scanning direction. Similarly, the holes 89 and 90 used to detect the edge position of an 8-cm disk can also be arranged near the recording start position for the recording medium relative to the centering position C for the mounting portion Tb in the sub-scanning direction.

Furthermore, in this embodiment, the holes 91 and 92 and the reflection marks 98 and 99 that are the second reflection marks are arranged near the recording start position relative to the centering position for the mounting portion Tb. Therefore, when the x-directional printing centering position Px is used as a tray reference position (Px=Tcx), the detection process for the x-directional centering position for the mounting portion Tb (step S102 in FIG. 6) may be performed last. Also in this case, the same effects can be obtained, i.e., the sub-scanning feeding distance whereat tho tray T is to be moved to the search position can be shortened, and the shifting of the centering position due to the skewed feeding of the tray 1 can be prevented.

In this embodiment, the holes (holes 83 to 90) have been armed at positions corresponding to the edge position of a recording medium in order to accurately detect the edge of the recording medium. However, a difference in the reflectivity may be provided between the tray main body Ta or the mounting portion Tb and the recording medium. In this manner, without forming the holes 83 to 90, the RW sensor 80 can directly detect the boundary between the recording medium and the tray main body Ta or the mounting portion Tb, i.e., can detect the edge position of the recording medium. According to this arrangement, to obtain the x-directional centering position for the recording medium, the drive controller 60 of the printer 1 controls the main scanning driver 57 and the sub-scanning driver 59 (FIG. 1), so that the PW sensor 80 performs sensing (scanning) near the recording start position (the lower portion in FIG. 4 in this embodiment) relative to the centering position C for the mounting portion Tb in the sub-scanning direction, and thereafter, the tray T is moved to the search position. In this manner, the sub scanning feeding distance whereat the tray T is to be moved to the search position can be shortened, and thus, the shifting of the centering position due to the skewed feeding of the tray T can be prevented.

What is claimed is:

1. A tray comprising:
a plate-shaped tray main body adapted to be moved in a sub-scanning direction by a conveying roller for conveying a sheet to a location opposite a recording head that executes recording on the sheet;
a mounting portion, formed in the tray main body, for mounting a first thin plate member on which recording is to be executed by the recording head, the mounting portion having a centering position; and
a first pair of first marks that are different in light reflectivity from the first thin plate member and that are located at least partly in the mounting portion to correspond to edge positions of the first thin plate member when the first thin plate member is mounted on the mounting portion,
wherein the first marks of the first pair are located symmetrical to each other, in a main scanning direction, relative to the centering position of the mounting portion, and are both located in a side of a recording start position, in the sub scanning direction, relative to the centering position of the mounting portion.

2. A tray according to claim 1, wherein the first marks are formed as holes.

3. A tray according to claim 1, wherein a plurality of types of the thin plate members including the first thin plate member and a second thin plate member are selectively mountable on the mounting portion.

4. A tray according to claim 3, further comprising:
a second pair of first marks that are different in light reflectivity from the second thin plate member and that are located at least partly in the mounting portion to correspond to edge positions of the second thin plate member when the second thin plate member is mounted on the mounting portion,
wherein the first marks of the second pair are located symmetrical to each other, in the main scanning direction, relative to the centering position of the mounting portion, and are both located in the side of the recording start position, in the sub-scanning direction, relative to the centering position of the mounting portion.

5. A tray according to claim 1, further comprising:
a pair of second marks that are different in light reflectivity from the tray main body, that are located outside the mounting portion, and that are located symmetrical to each other, in the main scanning direction, relative to the centering position of the mounting portion.

6. A tray according to claim 5, wherein the second marks are both located in the side of the recording start position, in the sub-scanning direction, relative to the centering position of the mounting portion.

7. A tray comprising:
a plate-shaped tray main body adapted to be moved in a sub-scanning direction by a conveying roller for conveying a sheet to a location opposite a recording head that executes recording on the sheet; and
a mounting portion, formed in the tray main body, for mounting a thin plate member on which recording is to be executed by the recording head, the mounting portion having a centering position; and
a pair of second marks that are different in light reflectivity from the tray main body and that are located outside the mounting portion,
wherein the second marks are located symmetric to each other, in a main scanning direction, relative to the centering position of the mounting portion, and are both located in a side of a recording start position, in the sub-scanning direction, relative to the centering position of the mounting portion.

8. A recording apparatus which is adapted to convey a tray including a plate-shaped tray main body and a mounting portion, formed in the tray main body, for mounting a thin plate member and which is adapted to execute recording on the thin plate member mounted on the mounting portion, the recording apparatus comprising:
a carriage that has a recording head, and that is driven to reciprocate in a main scanning direction;
a conveying roller for conveying the tray having the thin plate member mounted thereon in a sub-scanning direction to be opposed to the recording head;
an optical sensor disposed on the carriage to detect change of light reflectivity during relative movement between the carriage and the tray;
a carriage position detecting means for detecting position of the carriage in the main scanning direction;
a conveying amount detecting means for detecting an conveying amount of the tray in the sub-scanning direction by the conveying roller; and
a controller that receives detection results of the optical sensor, the carriage position detecting means and the conveying amount detecting means, and that controls the carriage and the conveying roller based on the received detection results,
wherein the controller is adapted to execute the following steps:
(a) moving the carriage in the main scanning direction to detect two first edge positions of the thin plate member using the optical sensor, wherein the two first edge positions are located symmetrical to each other, in the main-scanning direction; relative to a center position of the thin plate member, and both located in a side of a recording start position, in the sub-scanning direction, relative to the center position (if the thin plate member, and
(b) after the step (a) is executed, driving the conveying roller to position the recording head at the recording start position.

9. A recording apparatus according to claim 8, the controller is adapted to further execute the following step:
(c) before the step (a) is executed, moving the tray in the sub-scanning direction to detect two second edge positions of the thin plate member using the optical sensor, wherein the two second edge positions are located symmetrical to each other, in the sub-scanning direction, relative to the center position of the thin plate member.

10. A recording apparatus which is adapted to convey the tray constructed according to claim 1 or 7 and which is adapted to execute recording on the thin plate member mounted on the mounting portion, the recording apparatus comprising:
a carriage that has the recording head, and that is driven to reciprocate in the main scanning direction;
the conveying roller for conveying the tray having the thin plate member mounted thereon in the sub-scanning direction to be opposed to the recording head;
an optical sensor disposed on the carriage to detect change of light reflectivity during relative movement between the carnage and the tray;
a carriage position detecting means for detecting position of the carriage in the main scanning direction;
a conveying amount detecting means for detecting an conveying amount of the tray in the sub-scanning direction by the conveying roller; and
a controller that receives detection results of the optical sensor, the carriage position detecting means and the conveying amount detecting means, and that controls the carriage and the conveying roller based on the received detection results,
wherein the controller is adapted to execute the following steps:
(a) moving the carriage in the main scanning direction to detect boundary positions between the thin plate member and the respective first marks of the first pair using the optical sensor, and
(b) after the step (a) is executed, driving the conveying roller to position the recording head at the recording start position.

11. A recording apparatus according to claim 10, wherein:
the tray further comprises a pair of third marks that are different in light reflectivity from the thin plate member, that are located at least partly in the mounting portion to correspond to edge positions of the thin plate member when the thin plate member is mounted on the mounting portion, and that are located symmetrical to each other, in the sub-scanning direction, relative to the centering position of the mounting portion; and
the controller is adapted to further execute the following step:
(c) before the step (a) is executed, moving the tray in the sub-scanning direction to detect boundary positions between the thin plate member and the respective third marks using the optical sensor.

12. A recording apparatus which is adapted to convey the tray constructed according to claim 7 and which is adapted to execute recording on the thin plate member mounted on the mounting portion, the recording apparatus comprising:
a carriage that has the recording head, and that is driven to reciprocate in the main scanning direction;
the conveying roller for conveying the tray having the thin plate member mounted thereon in the sub-scanning direction to be opposed to the recording head;
an optical sensor disposed on the carriage to detect change of light reflectivity during relative movement between the carriage and the tray;
a carriage position detecting means for detecting position of the carriage in the main scanning direction;
a conveying amount detecting means for detecting an conveying amount of the tray in the sub-scanning direction by the conveying roller; and
a controller that receives detection results of the optical sensor, the carriage position detecting means and the conveying amount detecting means, and that controls the carriage and the conveying roller based on the received detection results,
wherein the controller is adapted to execute the following steps:
(d) moving the carriage in the main scanning direction to detect edge positions of the second marks using the optical sensor; and
(e) after the step (d) is executed, driving the conveying roller to position the recording head at the recording start position.

13. A recording apparatus according to claim 12, wherein:
the tray further comprises a pair of fourth marks that are different in light reflectivity from the tray main body, that are located outside the mounting position and that are located symmetrical to each other, in the sub-scanning direction, relative to the centering position of the mounting portion; and
the controller is adapted to further execute the following step:
(f) before the step (d) is executed, moving the tray in the sub-scanning direction to detect edge positions of the fourth marks using the optical sensor.
